(19) United States
(12) Patent Application Publication
(10) Pub. No.: US 2019/0228933 A1
(43) Pub. Date: Jul. 25, 2019

(54) SWITCH DEVICE AND MUSIC GENERATION DEVICE

(71) Applicant: Roland Corporation, Shizuoka (JP)

(72) Inventor: Norihiko WADA, Hamamatsu (JP)

(73) Assignee: Roland Corporation, Shizuoka (JP)

(21) Appl. No.: 16/254,590

(22) Filed: Jan. 23, 2019

(30) Foreign Application Priority Data
Jan. 23, 2018 (JP) 2018-009221

(51) Int. Cl. H01H 13/84; H01H 13/52; G10H 1/34

(52) U.S. Cl. CPC H01H 13/84; H01H 13/52; H01H 2231/018; H01H 2221/064; H01H 2227/036; G10H 1/34

(57) ABSTRACT

A switch device and a music generation device are provided. A switch device comprising: a switch; a housing; a movable shaft that moves with respect to the housing to press the switch; an elastic member that biases the movable shaft to one end side of the movable shaft in an axial direction; and an arm for pressing the switch at a position eccentric from an axis of the movable shaft.

### CROSS-REFERENCE TO RELATED APPLICATION

This application claims the priority of Japan patent application serial no. 2018-009221, filed on Jan. 23, 2018. The entirety of the above-mentioned patent application is hereby incorporated by reference herein and made a part of this specification.

### BACKGROUND

### Technical Field

The disclosure relates to a switch device and a music generation device, particularly relates to a switch device and a music generation device that can obtain both a feeling of pressing a movable shaft and miniaturization of the switch device at the same time.

### Description of Related Art

Music generation devices with switch devices operated by performers (e.g., effect devices such as an effector and electronic musical instruments such as an electronic piano) are known. For example, Patent Document 1 discloses a switch device in which a substrate is covered by a cover member formed of a flexible material and a movable contact (movable contact protrusion) is formed as one body with the cover member. In this switch device, a thick part is supported by a pair of side walls formed to be perpendicular to the substrate and the movable contact is formed on a bottom surface of the thick part (a surface on the substrate side).

### PATENT DOCUMENTS

[Patent Document 1] Japanese Laid-open No. 2001-093368 (for example, paragraphs 0022, 0023, and 0026, and FIG. 4)
[Patent Document 2] Japanese Utility Model Publication No. H05-034624 (for example, paragraph 0012, and FIG. 1)

However, since the cover member is formed of a flexible material in the above-described related art, it is difficult to have a feeling of pressing the upper surface of the movable contact. Meanwhile, Patent Document 2 describes a switch device that includes an outer frame that is fixed to a housing of an electronic musical instrument, a movable shaft (a depressing member) that is slidably inserted into the outer frame and has a lower end disposed to face a switch, and a return spring that biases the movable shaft upward.

With respect to the switch device, since the movable shaft is displaced downward resisting a biasing force of the return spring when the movable shaft is pressed, a feeling of pressing the movable shaft can be easily obtained. However, since the switch is disposed to face the movable shaft in the direction in which the movable shaft is pressed in the related art, there is the problem that the size of the switch device increases in the direction in which the movable shaft is pushed.

### SUMMARY

A switch device and a music generation device according to the disclosure include a switch, a housing, a movable shaft that moves with respect to the housing to press the switch, an elastic member that biases the movable shaft to one end side of the movable shaft in an axial direction, and an arm for pressing the switch at a position eccentric from an axis of the movable shaft.

### BRIEF DESCRIPTION OF THE DRAWINGS

FIG. 1(a) is a partially enlarged perspective view of an effect device on which switch devices according to a first embodiment are disposed, and FIG. 1(b) is a partially enlarged top view of the effect device viewed in the direction of the arrow Ib of FIG. 1(a).

FIG. 2(a) is a partially enlarged cross sectional view of the effect device cut at the line IIa-IIa of FIG. 1(b), and FIG. 2(b) is a partially enlarged cross sectional view of the effect device cut on the line IIb-IIb of FIG. 2(a).

FIG. 3 is a partially enlarged cross sectional view of the effect device showing a state in which a switch device is depressed from the state of FIG. 2(a).

FIG. 4(a) is a partially enlarged cross sectional view of an effect device according to a second embodiment, and FIG. 4(b) is a partially enlarged cross sectional view of the effect device cut on the line IVb-IVb of FIG. 4(a).

FIG. 5(a) is a partially enlarged cross sectional view of the effect device showing a state in which a switch device is depressed from the state of FIG. 4(b), and FIG. 5(b) is a schematic view showing an outline shape of an arm viewed in an axial direction.

### DESCRIPTION OF THE EMBODIMENTS

One of the embodiments of the disclosure provide a switch device and a music generation device can obtain both a feeling of pressing a movable shaft and miniaturization of the switch device at the same time.

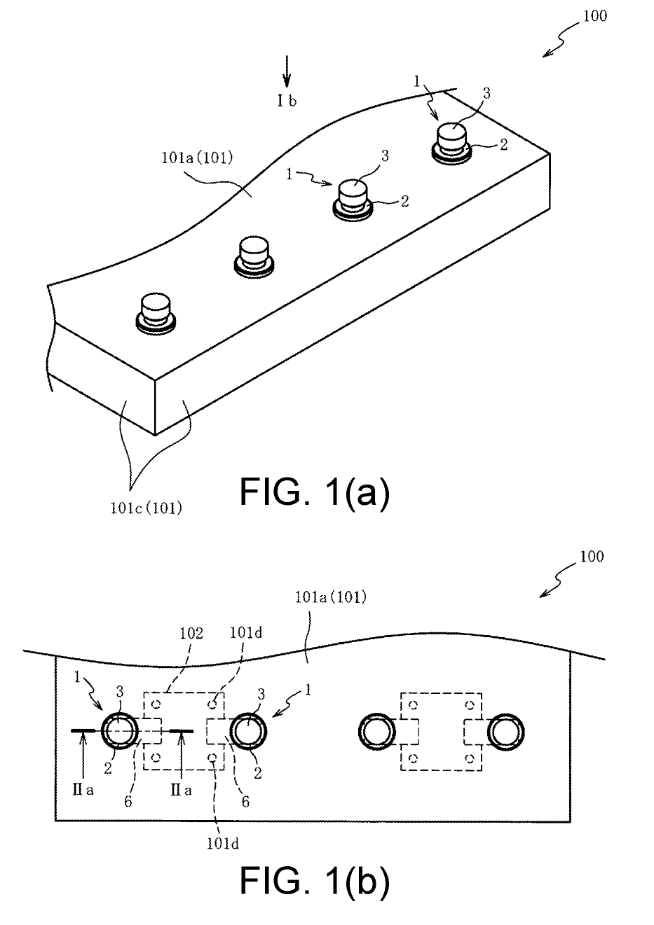

Exemplary embodiments will be described below with reference to the accompanying drawings. First, configurations of switch devices 1 and an effect device 100 will be described with reference to FIG. 1. FIG. 1(a) is a partially enlarged perspective view of the effect device 100 on which the switch devices 1 according to a first embodiment are disposed, and FIG. 1(b) is a partially enlarged top view of the effect device 100 viewed in the direction of the arrow Ib of FIG. 1(a). Note that, in FIG. 1, the effect device 100 is schematically illustrated by omitting a part thereof for the sake of simplification of the drawing.

The effect device 100 is a music generation device for applying an effect to a music signal output from an electronic musical instrument (an electronic guitar in the present embodiment) and outputting the effect to an external device (e.g., an amplifier, or a speaker), which is not illustrated, as illustrated in FIG. 1. The effect device 100 includes an operator (e.g., a rotary knob or a foot pedal), which is not illustrated, and the switch devices 1, and various kinds of setting (e.g., a setting of an output level of a music signal, a setting of ON/OFF of an effect, a setting of a type of effect to be applied, and the like) are made using the operator and the switch devices 1.

The operator and the switch devices 1 are disposed on the upper surface (an operation panel) of a housing 101 of the effect device 100, and the plurality of switch devices 1 (four in the present embodiment) are disposed in a width direction (the left-right direction of FIG. 1(b)) of the housing 101. The effect device 100 is used in a state of being placed on a floor, and the switch devices 1 are configured as foot switches that are operated (depressed) with a foot while a performer is playing an electronic musical instrument.

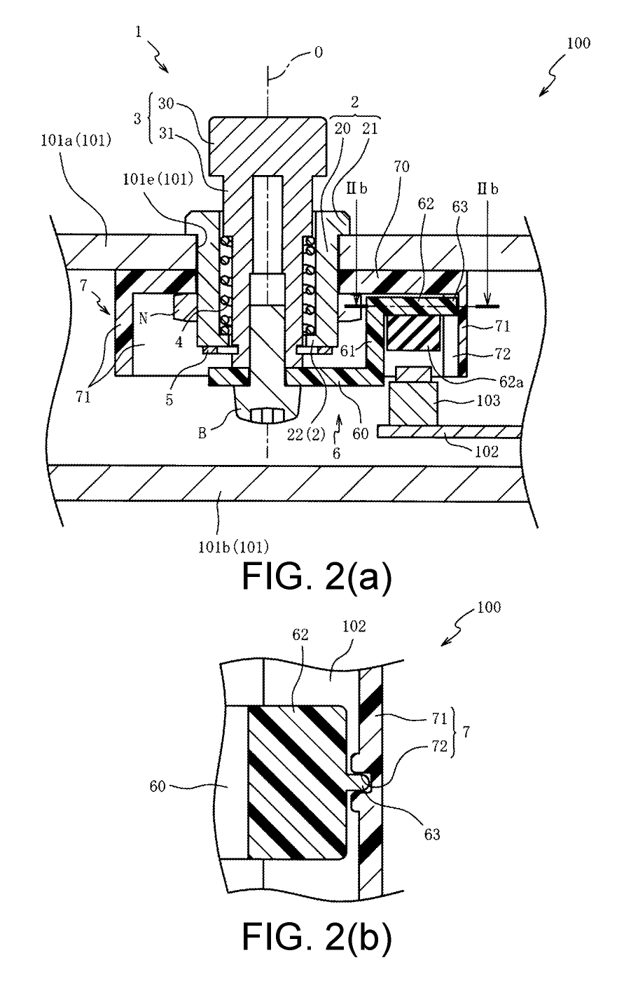

The housing 101 has an upper plate 101a forming the upper surface thereof, a lower plate 101b (see FIG. 2) disposed to face the lower side of the upper plate 101a, and side plates 101c connecting outer edges of the upper plate 101a and the lower plate 101b, and a space for disposing the switch devices 1 and substrates 102 is formed inside the housing 101. The substrate 102 is fixed to lower ends of fastening parts 101d dropping downward from the upper plate 101a of the housing 101 using bolts (not illustrated).

In other words, although not illustrated, since the substrate 102 is fixed to the fastening parts 101d, the substrate is disposed in a state in which the substrate is suspended from the upper plate 101a. Note that the substrate 102 may be fixed to the lower plate 101b by causing the fastening parts 101d to protrude upward from the lower plate 101b.

Next, a detailed configuration of the switch device 1 will be described with reference to FIG. 2. FIG. 2(a) is a partially enlarged cross sectional view of the effect device 100 cut along the line IIa-IIa of FIG. 1(b), and FIG. 2(b) is a partially enlarged cross sectional view of the effect device 100 cut along the line IIb-IIb of FIG. 2(a). Note that, the fastening parts 101d (see FIG. 1(b)) are not illustrated in FIG. 2(a) in order to simplify illustration. In addition, clearance between a movably shaft 31 and a pipe part 20 is illustrated in an exaggerated manner in FIG. 2(a) in order to make it easier to understand, and the same applies to the drawings from FIG. 2.

The switch device 1 is fixed to a through hole 101e vertically penetrating the upper plate 101a as illustrated in FIG. 2. The switch device 1 has a frame body 2 that is engaged with the through hole 101e, an operation member 3 that is inserted into the frame body 2 and is displaced with respect to the frame body 2, a return spring 4 that biases the operation member 3 upward (one end side in the axis O direction), a retaining ring 5 that is provided at the lower end side of the operation member 3 (the other end side in the axis O direction), an arm 6 that is fixed to the lower end of the operation member 3 using a bolt B below the retaining ring 5, and a guide member 7 that is disposed such that it surrounds the arm 6 and the frame body 2.

Note that, in the following description, a direction that is orthogonal to the axis O of the frame body 2 (i.e., the axis O of the movable shaft 31 in an initial state before the operation member 3 is depressed) will be referred to as a “radial direction,” and a direction around the axis O will be referred to as a “circumferential direction.”

The frame body 2 has the pipe-like pipe part 20, a first engagement part 21 projecting from an upper end of the pipe part 20 outward in the radial direction, and a second engagement part 22 projecting from a lower end of the pipe part 20 inward in the radial direction, and is formed of a metallic material. An outer diameter of the pipe part 20 is set to be equal to (or slightly smaller than) an inner diameter of the through hole 101e, and external threads are formed on an outer circumferential surface of the through hole. In a state in which the first engagement part 21 is engaged with an opening part at the upper end side of the through hole 101e, the frame body 2 (guide member 7) is fixed to the upper plate 101a by screwing a nut N to an outer circumferential surface of the pipe part 20.

The second engagement part 22 is set to have an inner diameter that is smaller than a diameter of the return spring 4, and the return spring 4 is supported on the upper surface of the second engagement part 22. The return spring 4 is configured using a coil spring, and the return spring 4 causes a downward displacement of the operation member 3 such that it returns to an initial position.

The operation member 3 has a cylindrical operation part 30 that is a portion on the upper end side of the operation member and is depressed by a performer, and the movable shaft 31 that extends from a lower side of the operation part 30 and is formed of a metallic material.

An outer diameter of the operation part 30 is set to be larger than an inner diameter of the pipe part 20, and a downward displacement of the operation member 3 with respect to the frame body 2 is restricted when the operation part 30 abuts against the upper surface of the pipe part 20.

The movable shaft 31 includes a large diameter part constituting a portion on the upper end side of the movable shaft and a small diameter part that extends downward from the large diameter part, and the lower end thereof is formed in an open pipe shape. An outer diameter of the large diameter part of the movable shaft 31 is set to be slightly smaller (e.g., 0.5 mm) than the inner diameter of the pipe part 20, and an outer diameter of the small diameter part of the movable shaft 31 is set to be slightly smaller (e.g., 0.5 mm) than an inner diameter of the second engagement part 22. In other words, the movable shaft 31 is inserted into the pipe part 20 with a clearance.

The return spring 4 is disposed between the bottom surface of the large diameter part of the movable shaft 31 and the upper surface of the second engagement part 22 (i.e., between an outer circumferential surface of the small diameter part of the movable shaft 31 and an inner circumferential surface of the pipe part 20). Accordingly, when a performer depresses the operation part 30 of the operation member 3, the return spring 4 elastically deforms between the large diameter part of the movable shaft 31 and the second engagement part 22, and when depression is released, the operation member 3 is biased such that it returns to the initial state due to elastic resilience of the return spring 4.

A recess part that recedes toward the axis O is formed at a lower end side of the small diameter part of the movable shaft 31 in the circumferential direction, and the retaining ring 5 is fitted into the recess part. The retaining ring 5 is an E ring disposed to abut against a bottom surface of the pipe part 20 in the initial state, and detachment of the operation member 3 upward from the frame body 2 is restricted by the retaining ring 5.

Internal threads are formed on the inner circumferential surface of the movable shaft 31, and the arm 6 is fixed to the lower end of the movable shaft 31 when a bolt B is screwed to the inner circumferential surface of the movable shaft 31.

The arm 6 is a member for pressing the switch 103 mounted on the substrate 102 and is formed of a resin material. The arm 6 has a first arm part 60 that extends from the lower end of the movable shaft 31 in the diameter direction, a second arm part 61 that is connected to the extension tip of the first arm part 60 (a tip part on the outer side in the radial direction) and extends upward, and a third arm part 62 that is connected to the upper end of the second arm part 61 and extends to the outer side in the radial direction, and each of the arm parts is formed in a flat plate shape.

The third arm part 62 is a portion for pressing the switch 103 and is disposed to vertically face the switch 103. A rectangular parallelepiped-shaped pressing part 62a for pressing the switch 103 is provided on the bottom surface of the third arm part 62, and the pressing part 62a is formed of a rubber-like elastic body.

Since the first arm part 60 extends from the lower end of the movable shaft 31 in the radial direction, the second arm part 61 connected to the first arm part 60 and the third arm part 62 can be disposed at positions eccentric (positions shifted) from the axis O. Thus, in comparison to a case where the switch 103 and the movable shaft 31 are disposed to face in the axis O direction, the switch 103 (the substrate 102) can be brought closer to the upper plate 101a side (the position on the switch 103 to be pressed (the upper end of the switch 103) is disposed above the lower end of the movable shaft 31), and thus the switch device 1 (the effect device 100) can be miniaturized in the axis O direction.

Furthermore, since the movable shaft 31 is biased upward by the return spring 4, the feeling of pressing the movable shaft 31 can be obtained. Thus, both the feeling of pressing the movable shaft 31 and miniaturization of the switch device 1 (the effect device 100) can be obtained at the same time.

In addition, since the second arm part 61 extends upward from the extension tip of the first arm part 60, the third arm part 62 (pressing part 62a) that is connected to the upper end of the second arm part 61 can be brought as close to the upper plate 101a side as possible. Thus, the switch 103 (the substrate 102) can be brought close to the upper plate 101a side, the switch device 1 (the effect device 100) can be miniaturized in the axis O direction.

The guide member 7 has a rectangular upper plate part 70 having a through hole with an inner diameter equal to (or slightly smaller than) the outer diameter of the pipe part 20 and side plate parts 71 that drop downward from outer edges of the upper plate part 70, and is formed of a resin material.

In the state in which the frame body 2 is engaged with the through hole 101e of the upper plate 101a, the pipe part 20 projects downward the upper plate 101a, the projection part of the pipe part 20 is fitted into a through hole of the upper plate part 70. When a nut N is screwed to an outer circumferential surface of the pipe part 20 in the state in which the pipe part 20 is fitted into the through hole of the upper plate part 70, the guide member 7 is fixed to the frame body 2 and the upper plate 101a (fastened together).

A guide part 72 is formed on an inner surface of the side plate part 71a among the side plate parts 71 of the guide member 7 which face an extension tip of the third arm part 62 in the radial direction. A guided part 63 that can be engaged with the guide part 72 is formed at the extension tip of the third arm part 62.

The guide part 72 is formed as a recessed groove receding outward in the radial direction and extends in the axis O direction. The guided part 63 is formed as a convex protrusion outward the radial direction, and engagement of the guided part 63 and the guide part 72 guides a displacement of the arm 6 in the axis O direction.

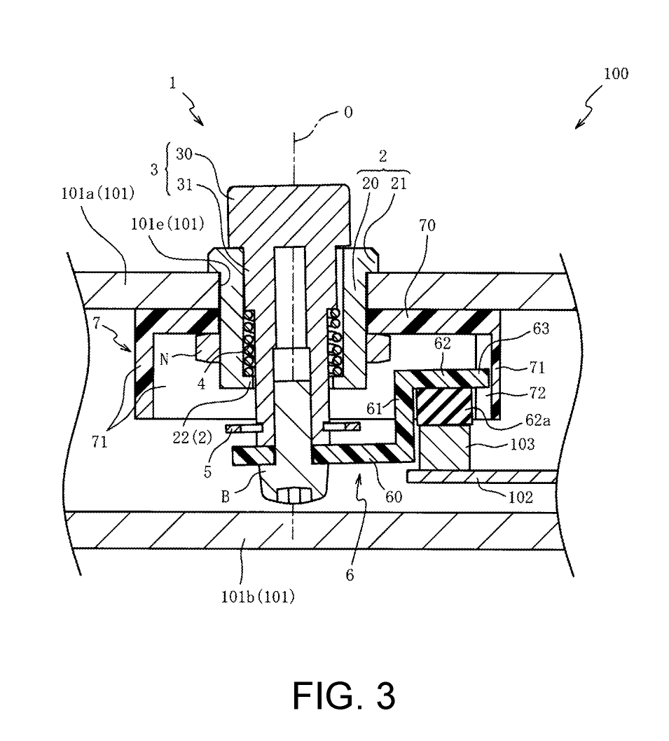

Next, a case where the switch device 1 is depressed by a performer will be described with reference to FIG. 3. FIG. 3 is a partially enlarged cross sectional view of the effect device 100 showing a state in which the switch device 1 is depressed from the state of FIG. 2(a).

When the operation part 30 of the operation member 3 is depressed by a performer with his or her foot, the movable shaft 31 is displaced (the operation member 3 is displaced downward) with respect to the pipe part 20, resisting a biasing force of the return spring 4 as illustrated in FIG. 3. Since the arm 6 is fixed to the lower end of the movable shaft 31, the arm 6 is also displaced together with the movable shaft 31, and thus the switch 103 is pressed by the pressing part 62a.

The downward displacement of the arm 6 is guided by the engagement (sliding) of the guided part 63 and the guide part 72. In this case, since the guided part 63 and the guide part 72 are formed in a convex shape and a concave shape in the radial direction, rotation of the movable shaft 31 around the axis O can be restricted by the engagement of the guided part 63 and the guide part 72. In other words, both the function of guiding the displacement of the arm 6 and the function of restricting the rotation of the movable shaft 31 can be served by the guided part 63 and the guide part 72.

Since the position on the switch 103 to be pressed by the pressing part 62a of the third arm part 62 is a place eccentric from the axis O, when the switch 103 is pressed by the pressing part 62a, a reaction force from the switch 103 works in the direction in which the movable shaft 31 tilts toward the axis O (prying direction). At this time, since the movable shaft 31 has been inserted into the pipe part 20 with a clearance, the applied reaction force can cause the movable shaft 31 to tilt in the pipe part 20. Since the tilting of the movable shaft 31 makes the arm 6 tilt as well, a load imposed on the switch 103 can be reduced when the arm 6 (pressing part 62a) presses the switch 103. Thus, even if the performer depresses the operation part 30 strongly, it is possible to prevent the switch 103 from being damaged.

Here, the switch devices 1 are configured as a plurality of foot switches disposed in parallel in the width direction of the housing 101 (see FIG. 1). Thus, in order to ensure operability with respect to the feet of performers (to allow a performer to depress one switch device 1 with his or her foot), the switch devices 1 are disposed at predetermined intervals (e.g., 65 mm or greater). In this case, for example, if the switch 103 is disposed to face the movable shaft 31 in the axis O, the substrate 102 needs to be disposed below the movable shaft 31 of the switch device 1, and the substrate 102 needs to be formed to be relatively long in the direction in which the switch devices 1 are disposed in parallel.

On the other hand, since the third arm part 62 (the pressing part 62a) is disposed at a position eccentric from the axis O in the present embodiment, by disposing the third arm part 62 in a gap between the switch devices 1 facing each other (by causing the first arm part 60 and the third arm part 62 to extend toward a gap between the switch devices 1 facing each other), the substrate 102 can be miniaturized in the direction in which the plurality of switch devices 1 are disposed in parallel.

Furthermore, even in a case where the arm 6 extends in the radial direction of the movable shaft 31 (the switch device 1 becomes larger in the direction in which the first arm part 60 and the third arm part 62 extend), by extending the arm 6 toward the gap between the switch devices 1 facing each other with a relatively sufficient space therebetween, the space inside the housing 101 can be used with efficiency.

In addition, since the arm 6 is fixed to the movable shaft 31 using the bolt B and the arm 6 is detachable from the movable shaft 31, even if the disposition position on the switch 103 is changed due to a design change of the substrate 102 or the like, the shape of the arm 6 can be appropriately changed (to a shape corresponding to the positional relationship between the axis O and the switch 103), the switch 103 can be pressed by the arm 6. Therefore, the degree of freedom of the disposition position on the switch 103 increases, and the degree of freedom in designing the effect device 100 is improved as well.

In this case, in a configuration in which a guide part (a constituent element corresponding to the guide part 72) is formed as one body with the upper plate 101a of the housing 101, for example, if the shape of the arm 6 is changed, the shape of the housing 101 needs to be changed.

On the other hand, since the guide member 7 (including the guide part 72) is detachable from the frame body 2 in the present embodiment, even if the shape of the arm 6 is changed, it is better to change the shape of the guide member 7 in accordance with the shape of the arm 6 (the disposition position of the guided part 63). In other words, even if the disposition position of the switch 103 (the shape of the arm 6) is changed, it is possible to make it unnecessary to change the shape of the housing 101.

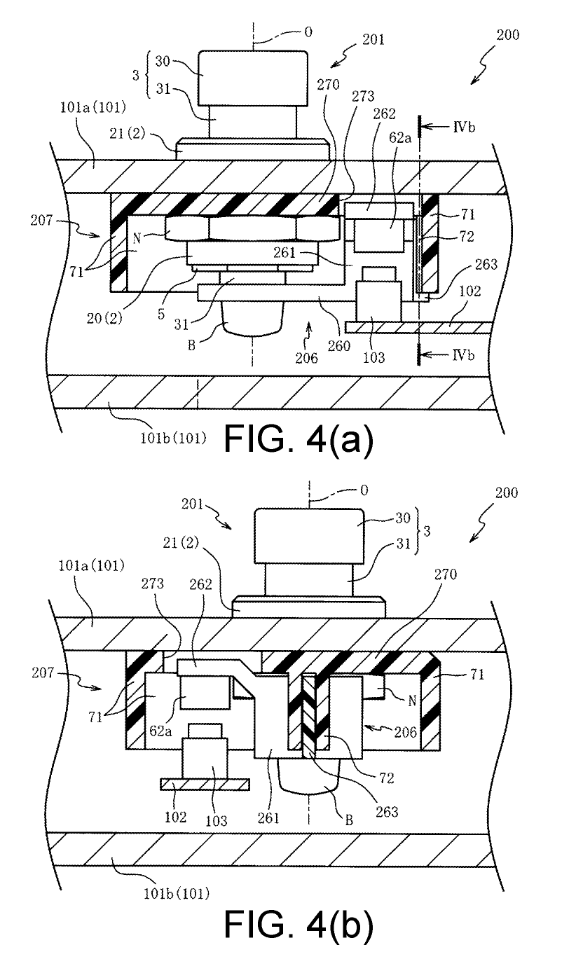

Next, a second embodiment will be described with reference to FIG. 4. Although the third arm part 62 extends from the upper end of the second arm part 61 in the radial direction in the first embodiment, in the second embodiment, a case where a third arm part 262 extends from an upper end of a second arm part 261 in the circumferential direction will be described. Note that the same reference numerals will be given to parts the same as those of the above-described first embodiment, and description thereof will be omitted.

FIG. 4(a) is a partially enlarged cross sectional view of an effect device 200 according to the second embodiment, and FIG. 4(b) is a partially enlarged cross sectional view of the effect device 200 cut along the line IVb-IVb of FIG. 4(a).

As illustrated in FIG. 4, the effect device 200 of the second embodiment has the same configuration as the effect device 100 of the first embodiment except that the former has differences in the shape of a substrate 102 and the disposition position of a switch 103, and a switch device 201 thereof has the same configuration as the switch devices 1 of the first embodiment except that the former has different configurations of an arm 206 and a guide member 207.

The arm 206 of the switch device 201 has a flat plate-like first arm part 260 extending from a lower end of a movable shaft 31 in the radial direction, a cylindrical second arm part 261 connected to an extension tip of the first arm part 260 (a tip part on the outer side in the radial direction) and extending upward, and a third arm part 262 connected to the upper end of the second arm part 261 and extending in the circumferential direction.

A guided part 263 extends in the axis O direction on an outer surface (the surface facing a guide part 72 in the radial direction) of the second arm part 261 to the outside in the radial direction. The guided part 263 is formed in a convex shape toward the outside in the radial direction and can be engaged with the guide part 72.

The third arm part 262 is constituted by an inclined part inclining upward from the upper end of the second arm part 261 and an extension part extending from the inclined part in the circumferential direction. A pressing part 62a is provided on the bottom surface of the extension part of the third arm part 262, and the switch 103 and the pressing part 62a are disposed to face in the axis O direction.

Since the first arm part 260 extends from the lower end of the movable shaft 31 in the radial direction and the second arm part 261 extends upward from the extension tip of the first arm part 260, the third arm part 262 (the pressing part 62a) can be positioned to be above the lower end of the movable shaft 31. Thus, the switch 103 (the substrate 102) can be brought closer to an upper plate 101a side than in a case where the switch 103 and the movable shaft 31 are disposed to face each other in the axis O direction, the switch device 201 (the effect device 200) can be miniaturized in the axis O direction.

Furthermore, since the movable shaft 31 is biased upward by a return spring 4 (see FIG. 3), the feeling of pressing the movable shaft 31 can be obtained. Thus, both the feeling of pressing the movable shaft 31 and miniaturization of the switch device 201 (the effect device 200) can be obtained at the same time.

The guide member 207 has the same configuration as the guide member 7 of the first embodiment except that a through hole 273 that houses the third arm part 262 is formed in an upper plate part 270.

Since the through hole 273 formed in the upper plate part 270 houses the third arm part 262, even when the guide member 207 is fastened to the frame body 2 and the upper plate 101a (the upper plate part 270 is interposed between the arm 206 and the upper plate 101a), the third arm part 262 can be disposed as close as possible to the upper plate 101a side. Thus, the switch 103 (the substrate 102) can be brought close to the upper plate 101a side accordingly, and thus the switch device 201 (the effect device 200) can be miniaturized in the axis O direction and another member can be disposed below the switch 103 (the substrate 102).

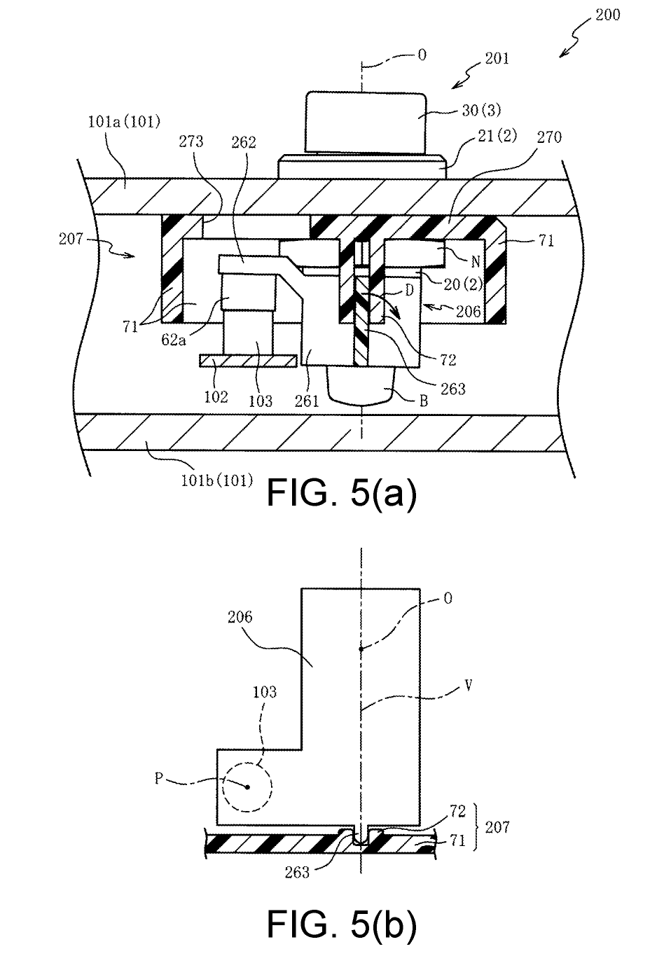

Next, a case where the switch device 201 is depressed by a performer will be described with reference to FIG. 5(a). FIG. 5(a) is a partially enlarged cross sectional view of the effect device 200 showing a state in which the switch device 201 is depressed from the state of FIG. 4(b).

When an operation part 30 of an operation member 3 is depressed by a performer with his or her foot as illustrated in FIG. 5(a), the arm 206 together with the operation member 3 are displaced downward, and thus the switch 103 is pressed by the pressing part 62a.

By appropriately changing the shape of the arm 206 so that the pressing part 62a is disposed to face the switch 103 in the axis O direction even when the disposition position of the switch 103 is changed as described above, the switch 103 can be pressed by the pressing part 62a. Thus, the degree of freedom of the disposition position of the switch 103 increases, and thus the degree of freedom in designing the effect device 200 is improved.

The downward displacement of the arm 206 is guided by engagement (sliding) of the guided part 263 and the guide part 72. Since the guided part 263 and the guide part 72 are formed in a convex shape and a concave shape in the radial direction, the function of guiding displacement of the arm 206 and the function of restricting rotation of the movable shaft 31 can be served by the guided part 263 and the guide part 72 as in the first embodiment.

In addition, by forming the guided part 263 using side surfaces of the second arm part 261 extending vertically, the guided part 263 can be formed to be longer in the axis O direction than the guided part 63 of the first embodiment. Accordingly, the guided part 263 and the guide part 72 can be engaged with each other in a relatively long size, they can guide displacement of the arm 206 stably.

When the switch 103 is pressed by the pressing part 62a, a reaction force from the switch 103 works with respect to the arm 206, and thus the movable shaft 31 and the arm 206 try to tilt as much as the clearance of the movable shaft 31, but excessive tilting thereof is restricted by engagement of the guided part 263 and the guide part 72 in the present embodiment.

Here, a positional relationship between the engagement position of the guided part 263 and the guide part 72, the pressing position P of the switch 103 by the pressing part 62a, and the axis O will be described with reference to FIG. 5(b). FIG. 5(b) is a schematic view showing an outline shape of the arm 206 viewed in the axis O direction.

Since the third arm part 262 extends from the second arm part 261 in the circumferential direction as illustrated in FIG. 5(b), the pressing position P of the switch 103 by the pressing part 62a is a position eccentric from a virtual line V connecting the protrusion direction of the guided part 263 (the central position of the engagement part of the guided part 263 and the guide part 72 in the circumferential direction) and the axis O in the circumferential direction.

Accordingly, when a reaction force from the switch 103 works with respect to the arm 206, the guided part 263 tilts in the circumferential direction (the arrow D direction) as illustrated in FIG. 5(a), but the corresponding tilting is restricted by the guided part 263 and the guide part 72 engaged in the axis O direction. In other words, tilting of the guided part 263 is tolerable to the extent of a slight gap between the guided part 263 and the guide part 72 in the circumferential direction (e.g., 0.5 mm), but further (excessive) tilting of the guided part 263 can be prevented.

Thus, while a load imposed on the switch 103 is reduced by causing the movable shaft 31 and the arm 206 to tilt when the switch 103 is pressed, excessive tilting of the movable shaft 31 and the arm 206 can be prevented. Therefore, while the switch 103 can be prevented from being damaged, a problem in a pressing operation with respect to the switch 103 (e.g., defective pressing) can be prevented.

Although the disclosure has been described above on the basis of the above-described embodiments, it is not limited thereto, and various modifications and alterations within the scope not departing from the gist of the disclosure can be conceived.

Although the effect devices 100 and 200 are exemplified as examples of music generation devices in which the switch devices 1 and 201 are provided in the above-described embodiments, the disclosure is not necessarily limited thereto. For example, the technical idea of the switch devices 1 and 201 can be applied to another music generation device such as an electronic musical instrument (e.g., an electronic piano) as well.

Although the case where the switch devices 1 and 201 are configured as foot switches has been described in the above-described embodiments, the disclosure is not necessarily limited thereto, and the switch devices 1 and 201 may be configured as switch devices of a type in which they can be pressed with a finger.

Although the case where the number of each of the switch devices 1 and 201 that are disposed in the effect devices 100 and 200 is four has been described in the above-described embodiments, the disclosure is not necessarily limited thereto, and the number of each of the switch devices 1 and 201 that are disposed in the effect devices 100 and 200 may be one, or two or more.

Although the case where the first arm parts 60 and 260 of the arms 6 and 206 extend (linearly) in the radial direction and the second arm parts 61 and 261 extend (linearly) in the axis O direction has been described in the above-described embodiments, the disclosure is not necessarily limited thereto. For example, an arm may be formed by combining linear and curved arm parts.

In other words, a shape of the arm can be appropriately set as long as it is positioned eccentric from the axis O, the third arm parts 62 and 262 are positioned above the lower end of the movable shaft 31, and the third arm parts 62 and 262 do not interfere with another member (the third arm parts 62 and 262 can be disposed to face the switch 103).

Thus, the arm may be formed, for example, linearly in the radial direction (including only the first arm parts 60 and 260). In this case, it is better for the arm to be connected above the lower end of the movable shaft 31. Accordingly, the switch 103 can be pressed by the arm (the first arm part 60 or 260) at a position eccentric from the axis O, and thus the switch 103 can be positioned above the lower end of the movable shaft 31.

Although the case where the movable shaft 31 is inserted into the housing 101 via the frame body 2 and the movable shaft 31 is biased by the return spring 4 disposed between the frame body 2 and the movable shaft 31 has been described in the above-described embodiments, the disclosure is not necessarily limited thereto. It is a matter of course that another member such as the frame body 2 can be omitted as long as the movable shaft 31 is biased to be displaced upward at least with respect to the housing 101, and a disposition position of the return spring 4 can also be appropriately set.

In other words, the technical idea of the above-described embodiments can be applied to a switch device and an effect device as long as they have at least a housing in which switches are disposed, a movable shaft that is displaced with respect to the housing, and an elastic member that biases the movable shaft upward. Thus, although the effect devices 100 and 200 are described as having the housing 101 in the above-described embodiments, the switch devices 1 and 201 may have a housing and the switch 103 may be disposed in the housing.

In addition, for example, the movable shaft 31 may be inserted directly into the through hole 101e of the housing 101 (the upper plate 101a) without the frame body 2. Also in this case, it is desirable to appropriately set diameters of the through hole 101e and the movable shaft 31 and to insert the movable shaft 31 having a clearance with respect to the through hole 101e. Accordingly, the movable shaft 31 (arm) can tilt when the switch 103 is pressed.

Although the case where, regarding a size of clearance of the movable shaft 31 with respect to the pipe part 20, an outer diameter of the large diameter part of the movable shaft 31 is set to be 0.5 mm smaller than an inner diameter of the pipe part 20 and an outer diameter of the small diameter part of the movable shaft 31 is 0.5 mm smaller than an inner diameter of the second engagement part 22 has been described in the above-described embodiments, the disclosure is not necessarily limited thereto, and corresponding size relationships can be appropriately set. In other words, the movable shaft 31 may be caused to have a clearance to the extent that no problem will occur in operations of pressing the switch 103 by the arms 6 and 206. In addition, the movable shaft 31 may be caused not to have a clearance such that the movable shaft 31 does not tilt (in a range in which the movable shaft can slide with respect to the pipe part 20).

Although the case where the movable shaft 31 and the arms 6 and 206 are tilted due to a clearance of the movable shaft 31 when the switch 103 is pressed has been described in the above-described embodiments, the disclosure is not necessarily limited thereto. For example, the arms 6 and 206 may be formed to have rigidity to the extent that they can be elastically deformed by a reaction force from the switch 103 when the switch 103 is pressed, and a load imposed on the switch 103 may be reduced due to the deformation of the arms 6 and 206.

Although the case where the guided parts 63 and 263 are formed in a convex shape in the radial direction and the guide part 72 is formed in a concave shape in the radial direction has been described in the above-described embodiments, the disclosure is not necessarily limited thereto, and for example, the guided parts 63 and 263 may be formed in a concave shape in the radial direction and the guide part 72 may be formed in a convex shape in the radial direction.

In addition, for example, wall parts that sandwich both side surfaces of the second arm part 61 and the third arm part 62 in the circumferential direction of the first embodiment may be caused to drop from the upper plate part 70 of the guide member 7. In this configuration, the second arm part 61 and the third arm part 62 correspond to a guided part and the wall parts of the guide member 7 correspond to a guide part. In addition, the guide members 7 and 207 may be omitted, and a configuration corresponding to the guide part 72 may be caused to drop from the upper plate 101a of the housing 101.

Although the return spring 4 formed using a coil spring has been exemplified as an elastic member that biases the operation member 3 (the movable shaft 31) upward in the above-described embodiments, the disclosure is not necessarily limited thereto. For example, another elastic member (e.g., a plate spring, etc.) may be used as long as it can energize the operation member 3 upward.

Although the case where the retaining ring 5 restricts the operation member 3 not to be detached from the frame body 2 has been described in the above-described embodiments, the disclosure is not necessarily limited thereto, and for example, the retaining ring 5 may be omitted and the first arm parts 60 and 260 may be set to also serve the function of the retaining ring 5. Accordingly, the number of components can be reduced.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A switch device comprising:
a switch;
a housing;
a movable shaft that moves with respect to the housing to press the switch;
an elastic member that biases the movable shaft to one end side of the movable shaft in an axial direction; and
an arm for pressing the switch at a position eccentric from an axis of the movable shaft.

2. The switch device according to claim 1, wherein the movable shaft is configured to be capable of being displaced with respect to the housing in a state of having a clearance.

3. The switch device according to claim 2, comprising:
a guide part that extends in the axial direction and is formed in a convex shape or a concave shape in a radial direction of the movable shaft,
wherein the arm has a guided part that is configured to be capable of being engaged with the guide part.

4. The switch device according to claim 3,
wherein the arm comprises a first arm part that is connected to the other end side of the movable shaft in the axial direction and extends in the radial direction of the movable shaft, a second arm part that is connected to an extension tip side of the first arm part and extends to one side in the axial direction, and a third arm part that is connected to an extension tip side of the second arm part and extends in the radial direction or a circumferential direction of the movable shaft that is a direction in which the third arm part does not overlap the first arm part in a view in the axial direction, and
wherein the guided part is formed in the second arm part and extends in the axial direction.

5. The switch device according to claim 4, wherein a pressing position of the switch by the third arm part in a view in the axial direction is set to a position shifted from a virtual line connecting the convex-shaped guide part or a protrusion direction of the guided part and the movable shaft.

6. The switch device according to claim 3 comprising:
a guide member in which the guide part is formed and the guide member is detachable from a frame body,
wherein the arm is detachable from the movable shaft.

7. The switch device according to claim 4 comprising:
a guide member in which the guide part is formed and the guide member is detachable from a frame body,
wherein the arm is detachable from the movable shaft.

8. The switch device according to claim 5 comprising:
a guide member in which the guide part is formed and the guide member is detachable from a frame body,
wherein the arm is detachable from the movable shaft.

9. A music generation device comprises the switch device according to claim 1.

10. A music generation device comprises the switch device according to claim 2.

11. A music generation device comprises the switch device according to claim 3.

12. A music generation device comprises the switch device according to claim 4.

13. A music generation device comprises the switch device according to claim 5.

14. A music generation device comprises the switch device according to claim 6.

15. A music generation device comprises the switch device according to claim 7.

16. A music generation device comprises the switch device according to claim 8.

17. The music generation device according to claim 9,
wherein the switch device is configured such that a plurality of switch devices are disposed in parallel as foot switches, and
wherein the arm extends towards a gap between the switch devices facing each other.

18. The music generation device according to claim 10,
wherein the switch device is configured such that a plurality of switch devices are disposed in parallel as foot switches, and
wherein the arm extends towards a gap between the switch devices facing each other.

19. The music generation device according to claim 11,
wherein the switch device is configured such that a plurality of switch devices are disposed in parallel as foot switches, and
wherein the arm extends towards a gap between the switch devices facing each other.

20. The music generation device according to claim 12,
wherein the switch device is configured such that a plurality of switch devices are disposed in parallel as foot switches, and
wherein the arm extends towards a gap between the switch devices facing each other.
